(19) United States
(12) Patent Application Publication
(10) Pub. No.: US 2009/0100136 A1
(43) Pub. Date: Apr. 16, 2009

(54) INTELLIGENT PRESENCE

(75) Inventors: Pontus JARENSKOG, Malmo (SE); Marten JONSSON, Malmo (SE); Martin WEZOWSKI, Malmo (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/099,315

(22) Filed: Apr. 8, 2008

Related U.S. Application Data
(60) Provisional application No. 60/979,923, filed on Oct. 15, 2007.

(51) Int. Cl. G06F 15/16; G06F 17/30

(52) U.S. Cl. 709/204; 707/104.1

(57) ABSTRACT

A method and apparatus for obtaining contact information for individuals using an electronic device is disclosed. The user creates a user profile and storing the profile in the electronic device and creates a preference list of desired characteristics and storing the list in the electronic device; The electronic device registers with a communication system wherein the user profile and the preference list is sent to the communication system. The electronic device receives contact information for all registered users of the communication system who have at least a predetermined percentages of desired characteristics based on a comparison of their user profile and the preference list.

### TECHNICAL FIELD OF THE INVENTION

The present invention relates to the transfer of public contact information and more particularly to a method and apparatus for targeting to whom the public contact information is sent.

### DESCRIPTION OF RELATED ART

Business cards have been a staple of business life for centuries. The paper cards typically contain a person's name, company title, address, telephone and email contact information and are exchanged during face to face meetings.

One problem with the use of business cards to convey contact information is that they are easily lost or destroyed. Furthermore, business people now generally try to keep other people's contact information on portable electronic devices, such as cell phones Personal Digital Assistants (PDAs), laptop computers, etc. Thus, when a person receives a paper business card, the contact information must then be entered into their portable electronic device.

In the past decade, digital or virtual business cards have been created. A person creates a virtual business card and enters their contact information into the virtual business card. These virtual business cards are stored on portable electronic devices such as cell phones, PDAs, laptop computers, stand alone vcards, etc. In use, when the portable electronic device comes within the proximity of another portable electronic device which is enabled to send and receive virtual business cards, the portable electronic devices will query each user to determine if the users want to exchange business cards. If both users want to exchange business cards, each portable electronic device transfers its virtual business card to the other device. The contact information can then be stored in the electronic devices in, for example, an address book.

While the virtual business cards are convenient and easy to use, the user still must decide to whom to share the contact information. Furthermore, the virtual business card does not help a user find potential clients or business people that the user would like to meet. For example, if the user goes to a trade show with their virtual business card, the user must meet other people with similar business interests before the user will exchange their contact information.

Thus, there is a need for a method or apparatus which allows users to target groups of people who have similar interests and exchanging contact information with the targeted group of people even if the user does not meet the targeted people face to face.

### SUMMARY OF THE INVENTION

According to some embodiments of the invention, a method for obtaining contact information for individuals using an electronic device, comprising the steps of: creating a user profile and storing the profile in the electronic device; creating a preference list of desired characteristics and storing the list in the electronic device; registering with a communication system wherein the user profile and the preference list is sent to the communication system; receiving contact information for all registered users of the communication system who have at least a predetermined percentages of desired characteristics based on a comparison of their user profile and the preference list.

According to another embodiment of the invention, a method for controlling access to contact information between registered users in a communication system comprising the steps of: receiving a user profile, user preference list and user contact information when a user registers with the communication system; comparing preference lists to user profiles of other registered users; transmit contact information of other registered users to the user where at least a predetermined percentage of characteristics in the user preference list match the characteristics in the user profile.

Further embodiments of the invention are defined in the dependent claims.

It is an advantage of embodiments of the invention that personal electronic devices may be used to target people for exchange of contact information based on either business or social criteria.

### BRIEF DESCRIPTION OF THE DRAWINGS

Further objects, features and advantages of embodiments of the invention will appear from the following detailed description of the invention, reference being made to the accompanying drawings, in which:

FIG. 1 illustrates an electronic device according to one embodiment of the invention;

FIG. 2 illustrates a wireless system according to one embodiment of the invention;

FIG. 3 a flow chart describing the operation of the system according to one embodiment of the invention; and

FIG. 4 is a flow chart describing the operation of the system according to one embodiment of the invention.

### DETAILED DESCRIPTION OF EMBODIMENTS

Specific illustrative embodiments of the invention will now be described with reference to the accompanying drawings. This invention may, however, be embodied in many different forms and should not be construed as limited to the embodiments set forth herein. Rather, the disclosed embodiments are provided so that this specification will be thorough and complete, and will fully convey the scope of the invention to those skilled in the art. The terminology used in the detailed description of the particular embodiments illustrated in the accompanying drawings is not intended to be limiting of the invention. Furthermore, in the drawings like numbers refer to like elements.

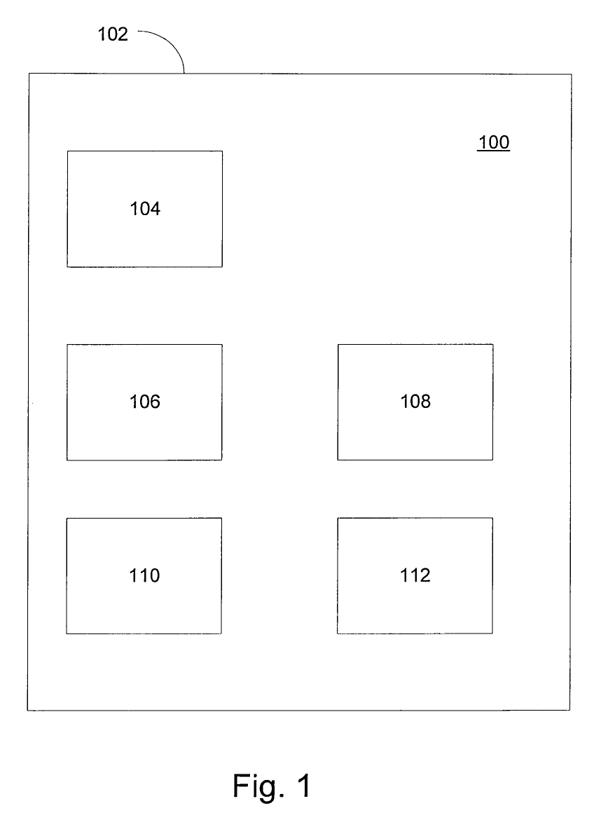

FIG. 1 illustrates an electronic device 100 according to one embodiment of the invention. The electronic device 100 comprises an antenna 102 and a transceiver 104 for communicating with at least one communication system. The connection to the communication system may be wireless or infrared but the invention is not limited thereto. The communication system may be one of various wireless or infrared systems, such as, near field, WiFi, GPS, Internet, Bluetooth, etc. and the invention is not limited thereto.

The operation of the electronic device 100 is controlled by at least one microprocessor 106 but the invention is not limited thereto. The microprocessor 106 runs various software to accomplish the desired operations of the electronic device 100. The microprocessor 106 is connected to at least one memory 108 and may be connected to a display 110 and a keypad/data entry device 112.

According to one embodiment of the invention, the electronic device 100 is used to participate in the possible exchange of contact information, e.g. electronic business cards, between various users. The electronic device 100 may be a cell phone, a Personal Digital Assistant (PDA), a laptop, a stand alone vCard, etc., and the invention is not limited thereto. In order to protect the privacy of the user, this feature can be turned on or off independently from the electronic device 100.

The electronic device 100 has stored in the memory 108 the user's contact information. The contact information may comprise the user's name, address, telephone/fax/mobile numbers, business, position, logo, picture, email address, website information, product line, etc. and the invention is not limited thereto.

The electronic device 100 also may store a user profile which contains information about the user in addition to the contact information. The user information may be related to the business or may be personal in nature. For example, the user profile may describe the user's educational background and special interests within the user's field of business and/or contact information. In the alternative, the user profile may describe the user's likes and dislikes about sports, travel, entertainment, food, relationships, etc. which would be helpful in selecting a person for a potential date.

In addition, the electronic device 100 also may store a user's preference list which describes various criteria or characteristics of people that the user would like to meet, either professionally or socially depending on the situation.

The contact information, user profile and user preference list may be entered into the electronic device 100 by entering information into one or more forms which are displayed on the display 110 via the keypad 112. Alternatively, the information can be entered into a separate electronic device, e.g. a desk top computer, and the downloaded to the electronic device 100 in a known manner.

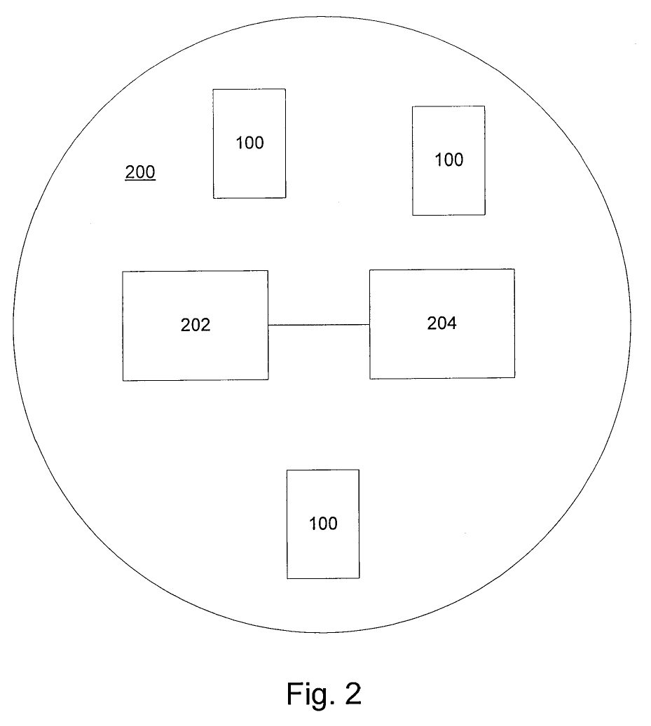

FIG. 2 illustrates a communication system 200 according to one embodiment of the invention. The communication system 200 may be a closed communication system with limited geographical coverage. For example, the communication system 200 may be a WiFi system which is set up to cover a trade show. Alternatively, the communication system may be an open communication system with a large geographic coverage and be connected to the Internet as will be illustrated later in different embodiments.

The communication system 200 has one or more base stations 202 for communicating with the plurality of electronic devices 100. The base station(s) is connected to a controller 204 which controls the operation of the communication system.

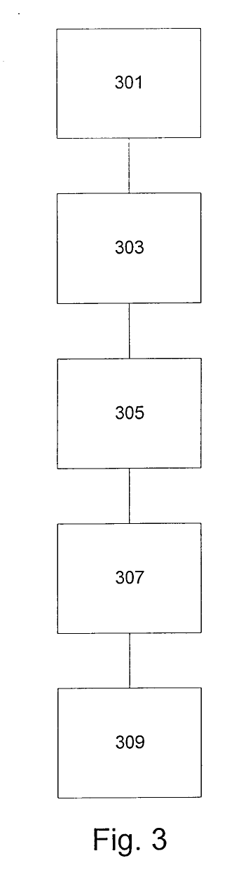

In this illustrative example as illustrated in FIG. 3, when a person with an electronic device 100 enters into the geographic area covered by the communication system 200, the communication system 200 detects the presence of the electronic device 100 in step 301 and asks the electronic device 100 to register in step 303. To register, the electronic device 100 sends the user's contact information, profile and/or preference list to the controller 204 in step 305. The controller 204 then compares the user's preference list to the user profiles of the other people registered in the communication system 200 in step 309. The controller 204 then send contact information to the user for people who match at least a predetermined number of the characteristics recited in the preference list. Likewise, the communication system 200 compares the user's user profile with the preference lists of the other registered users and sends the user's contact information to registered users as described above.

Furthermore, the communication system 200 can track the location of each registered user in the communication system. As a result, the communication system 200 can track certain groups of registered users with a specific interest. For example, the communication system 200 may detect that a first group of registered users at the trade show are interested in T-shirt sales, a second group of registered users are interested in sweater sales and a third group of registered users are interested in jacket sales. By monitoring the location of each registered user, the communication system can detect when a certain number of people interested in, for example, T-shirt sales are in close proximity of each other. The communication system 200 may then send out an indication of the location of this group of people to others who are interested in T-shirt sales. For example, the ceiling of the trade show may change colors over the location of the group and/or the communication system 200 may send alerts to the electronic devices 100 with the location of the group. Likewise, different alerts and colors may be used for the groups interested in sweater and jacket sales.

According to another embodiment of the invention the communication system 200 may also be used for dating. In one embodiment of the invention, the closed communication system 200 may be located in a bar, restaurant, gymnasium, etc. for the purpose of trying to match registered users with potential dates. In this embodiment, the user profile and preference list contain personal data as described above. When a user registers with the communication system 200, their electronic device 100 sends the user profile and preference list to the controller 204. The controller 204 then compares the user's preference list to the user profile of the other registered users. The controller 204 then sends an indication to the user and the selected users which list potential people to date based on the comparison. The indication may be contact information and/or the current location of these registered users (table number, seat number, etc.) and the invention is not limited thereto.

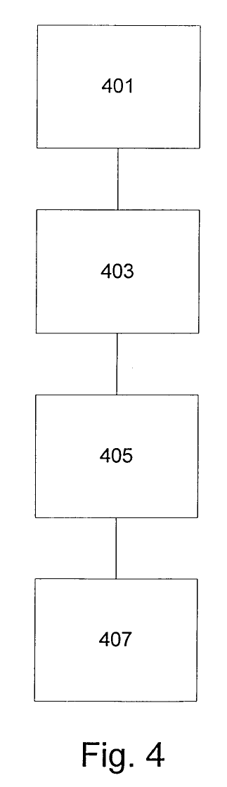

According to another embodiment of the invention, the comparisons of the user profiles and preference lists may be performed by the electronic devices 100 rather than the communication system 200. In this embodiment, as illustrated in FIG. 4, when the electronic device 100 detects, in step 401, the presence of another electronic device 100 in the communication system, the electronic devices 100 may exchange their user profiles in step 403. The microprocessor 106 in each electronic device 100 then compares their preference list with the received user profile in step 405. If a predetermined number of criteria match on the user profile and preference list, the electronic devices 100 exchange the contact information in step 407.

According to one embodiment of the invention, the contact information may be time sensitive or limited in some way so as to ensure the privacy of registered users. For example, the contact information may only be valid for a certain period of time, for example 6 months or for the length of the trade show or dating event. Furthermore, a Digital Rights Management standard may be used by the communication system 200 or electronic devices 100 so that the contact information can not be stolen or given by mistake.

Although the embodiments of the present invention described with reference to the drawings comprise communication system 200 or the electronic device 100 and processes performed in the communication system 200 or the electronic device 100, the invention also extends to a computer program product, which enables implementation of the method and functions described herein. The invention may be carried out when the computer program product is loaded and executed in a system having computer capabilities. Computer program, software program, program product, or software, in the present context mean any expression, in any programming language, code or notation, of a set of instructions intended to cause a system having a processing capability to perform a particular function directly or after conversion to another language, code or notation.

The present invention has been described above with reference to specific embodiments. However, other embodiments than the above described are equally possible within the scope of the invention. Different method steps than those described above, performing the method by hardware or software or a combination of hardware and software, may be provided within the scope of the invention. It should be appreciated that the different features and steps of the invention may be combined in other combinations than those described. The scope of the invention is only limited by the appended patent claims.

What is claimed is:

1. A method for obtaining contact information from individuals using an electronic device, comprising the steps of:
creating a user profile and storing the profile in the electronic device;
creating a preference list of desired characteristics and storing the list in the electronic device;
registering with a communication system wherein the user profile and the preference list is sent to the communication system;
receiving contact information for all registered users of the communication system who have at least a predetermined percentages of desired characteristics based on a comparison of their user profile and the preference list.

2. A method according to claim 1, further comprising:
creating contact information;
sending the contact information to the communication system during registration.

3. A method according to claim 1, wherein the user profile is contact information.

4. A method according to claim 1, wherein the preference list is created by filling in a form which is displayed on the electronic device.

5. A method according to claim 1, wherein the user profile is created by filling in a form which is displayed on the electronic device.

6. A method according to claim 1, wherein the user profile is created on a computer and is downloaded to the electronic device.

7. A method according to claims 1, wherein the preference list is created on a computer and is downloaded to the electronic device.

8. A method according to claim 1, wherein the communication system is a closed communication system with limited geographic coverage.

9. A method according to claim 1, wherein the preference list is a set of desired business characteristics.

10. A method according to claim 1, wherein the user profile comprises relevant business information.

11. A method according to claim 1, wherein the preference list is a set of desired personal characteristics.

12. A method according to claim 1, wherein the user profile comprises relevant personal information.

13. A method according to claim 1, wherein the communication system is an open communication system connected to the Internet.

14. A method for controlling access to contact information between registered users in a communication system comprising the steps of:
receiving a user profile, user preference list and user contact information when a user registers with the communication system;
comparing preference lists to user profiles of other registered users;
transmiting contact information of other registered users to the user where at least a predetermined percentage of characteristics in the user preference list match the characteristics in the user profile.

15. A method according to claim 14, wherein the communication system is a closed communication system with limited geographic coverage.

16. A method according to claim 14, wherein the preference list is a set of desired business characteristics.

17. A method according to claim 14, wherein the user profile comprises relevant business information.

18. A method according to claim 14, wherein the preference list is a set of desired personal characteristics.

19. A method according to claim 14, wherein the user profile comprises relevant personal information.

20. A method according to claim 14, wherein the communication system is an open communication system connected to the Internet.

21. A method for obtaining contact information from individuals using an electronic device in a communication system, comprising the steps of:
exchanging a stored user profile with a second electronic device;
comparing the exchanged user profile to a stored preference list;
requesting contact information from the second electronic device if a predetermined percentage of characteristics in the preference list match the characteristics in the exchanged user profile.

22. A method according to claim 21, further comprising the step of:
creating the user profile, preference list and contact information using the electronic device.

23. A method according to claim 21, further comprising the steps of:
receiving at least one of the user profile, preference list and contact information from an external device;
storing the received information.

24. A communication system for controlling access to contact information between registered users, comprising:
a receiver for receiving a user profile, user preference list and user contact information when a user registers with the communication system;
a microprocessor for comparing preference lists to user profiles of other registered users;
a transmitter for transmitting contact information of other registered users to the user where at least a predetermined percentage of characteristics in the user preference list match the characteristics in the user profile.

25. An apparatus for controlling access to contact information in an electronic device, comprising:
means for creating a user profile and storing the profile in the electronic device;
means for creating a preference list of desired characteristics and storing the list in the electronic device;
means for registering with a communication system wherein the user profile and the preference list is sent to the communication system;
means for receiving contact information for all registered users of the communication system who have at least a predetermined percentages of desired characteristics based on a comparison of their user profile and the preference list.

26. An apparatus for obtaining contact information from individuals using an electronic device in a communication system, comprising:
a transceiver for exchanging a stored user profile with a second electronic device;
a microprocessor for comparing the exchanged user profile to a stored preference list, wherein contact information is requested from the second electronic device if a predetermined percentage of characteristics in the preference list match the characteristics in the exchanged user profile.
